(19) United States
(12) Patent Application Publication
(10) Pub. No.: US 2024/0070622 A1
(43) Pub. Date: Feb. 29, 2024

(54) METHODS AND INTERNET OF THINGS (IOT) SYSTEMS FOR FULL-CYCLE MANAGEMENT OF SMART GAS EQUIPMENT BASED ON BIG DATA

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Bin LIU, Chengdu (CN)

(73) Assignee: CHENGDU QINCHUAN IOT TECHNOLOGY CO., LTD., Chengdu (CN)

(21) Appl. No.: 18/503,225

(22) Filed: Nov. 7, 2023

(30) Foreign Application Priority Data
Sep. 19, 2023 (CN) 202311209787.8

(51) Int. Cl. G06Q 10/20; G06Q 50/06; G16Y 40/10; G16Y 40/20

(52) U.S. Cl. CPC G06Q 10/20; G06Q 50/06; G16Y 40/10; G16Y 40/20

(57) ABSTRACT

The present disclosure provides a method and an Internet of Things (IoT) system for full-cycle management of smart gas equipment based on the big data, implemented by a smart gas equipment management platform of IoT system for full-cycle management of smart gas equipment based on big data. The method comprises obtaining operation data of gas equipment by generating a data obtaining instruction based on a preset cycle, generating a partitioning instruction based on the operation data, determining first partitioning data and second partitioning data based on the partitioning instruction, and determining a maintenance scheme for the gas equipment based on the first partitioning data and/or the second partitioning data.

### CROSS-REFERENCE TO RELATED APPLICATIONS

This application claims priority to Chinese Patent Application No. 202311209787.8, filed on Sep. 19, 2023, the entire content of which is hereby incorporated by reference.

### TECHNICAL FIELD

The present disclosure relates to the technical field of the Internet of Things (IoT), and in particular, to a method, IoT system, and medium for full-cycle management of smart gas equipment based on big data.

### BACKGROUND

A smart gas management platform involves a large number and various types of gas equipment, which generate a substantial amount of sensor data with different types and low value density, thereby causing difficulties in effectively managing, evaluating, and analyzing the data. However, it is crucial to efficiently analyze and utilize the data in the usage, maintenance, repair, and overhaul of gas equipment. Currently, the assessment and analysis of gas-related equipment primarily focus on analyzing data related to the faulty or hazardous conditions, aiming to prevent gas leakage or explosions, with less emphasis on the assessment and analysis of the gas equipment in a normal operation state. Analysis and assessment of data volumes associated with the normal operation state of the gas equipment are crucial aspects of the gas equipment management.

Therefore, it is desirable to provide a method and an IoT system for full-cycle management of gas equipment based on big data, which can effectively utilize the data from the normal operation process of the gas equipment, and offer data support for usage, maintenance, repair, and overhaul of the gas equipment.

### SUMMARY

One or more embodiments of the present disclosure provide a method for full-cycle management of gas equipment based on big data. The method may be implemented by a smart gas equipment management platform of an IoT system for a full-cycle management of smart gas equipment based on big data, comprising: obtaining operation data of gas equipment by generating a data obtaining instruction based on a preset cycle; generating a partitioning instruction based on the operation data, and determining first partitioning data and second partitioning data based on the partitioning instruction, the first partitioning data being normal operation data of the gas equipment, and the second partitioning data being sub-normal operation data of the gas equipment; and determining a maintenance scheme for the gas equipment based on the first partitioning data and/or the second partitioning data, the maintenance scheme including a maintenance cycle and/or a maintenance degree of the gas equipment.

One or more embodiments of the present disclosure provide an IoT system for full-cycle management of smart gas equipment based on big data. The IoT system may comprise a smart gas user platform, a smart gas service platform, a smart gas equipment management platform, a smart gas sensor network platform, and a smart gas object platform. The smart gas user platform may include a plurality of smart gas user sub-platforms. The smart gas service platform may include a plurality of smart gas service sub-platforms. Different smart gas service sub-platforms may correspond to different smart gas user sub-platforms. The smart gas equipment management platform may include a plurality of smart gas equipment management sub-platforms and a smart gas data center. The smart gas sensor network platform may be configured to interact with the smart gas data center and the smart gas object platform. The smart gas object platform may be configured to obtain operation data of gas equipment based on a data obtaining instruction generated in a preset cycle, and upload the operation data of the gas equipment to the smart gas data center based on the smart gas sensor network platform. The smart gas equipment management platform may be configured to obtain the operation data of the gas equipment from the smart gas data center; generate a partitioning instruction based on the operation data, and determine first partitioning data and second partitioning data based on the partitioning instruction, the first partitioning data being normal operation data of the gas equipment, and the second partitioning data being sub-normal operation data of the gas equipment; determine a maintenance scheme for the gas equipment based on the first partitioning data and/or the second partitioning data, the maintenance scheme including a maintenance cycle and/or a maintenance degree of the gas equipment; and transmit the maintenance scheme to the smart gas service platform through the smart gas data center. The smart gas service platform may be configured to upload the maintenance scheme to the smart gas user platform.

One or more embodiments of the present disclosure provide a non-transitory computer-readable storage medium, comprising computer instructions that, when read by a computer, may direct the computer to perform the method for full-cycle management of the smart gas equipment based on the big data.

### BRIEF DESCRIPTION OF THE DRAWINGS

The present disclosure will be further illustrated by way of exemplary embodiments, which will be described in detail with the accompanying drawings. These embodiments are non-limiting. In these embodiments, the same count indicates the same structure, wherein:

FIG. 1 is a diagram illustrating a platform structure of an IoT system for full-cycle management of smart gas equipment based on big data according to some embodiments of the present disclosure;

FIG. 2 is a flowchart illustrating a method for full-cycle management of smart gas equipment based on big data according to some embodiments of the present disclosure;

FIG. 3 is a schematic diagram illustrating a determination of a partitioning threshold according to some embodiments of the present disclosure; and

FIG. 4 is a schematic diagram illustrating a determination of a health status based on a model according to some embodiments of the present disclosure.

### DETAILED DESCRIPTION

In order to more clearly illustrate the technical solutions of the embodiments of the present disclosure, the following briefly introduces the drawings that need to be used in the description of the embodiments. Apparently, the accompanying drawings in the following description are only some examples or embodiments of the present disclosure, and those skilled in the art can also apply the present disclosure to other similar scenarios according to the drawings without creative efforts. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, parts, portions or assemblies of different levels. However, the words may be replaced by other expressions if other words can achieve the same purpose.

As indicated in the disclosure and claims, the terms “a”, “an”, and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The flowchart is used in the present disclosure to illustrate the operations performed by the system according to the embodiments of the present disclosure. It should be understood that the preceding or following operations are not necessarily performed in the exact order. Instead, various steps may be processed in reverse order or simultaneously. Meanwhile, other operations may be added to these procedures, or a certain step or steps may be removed from these procedures.

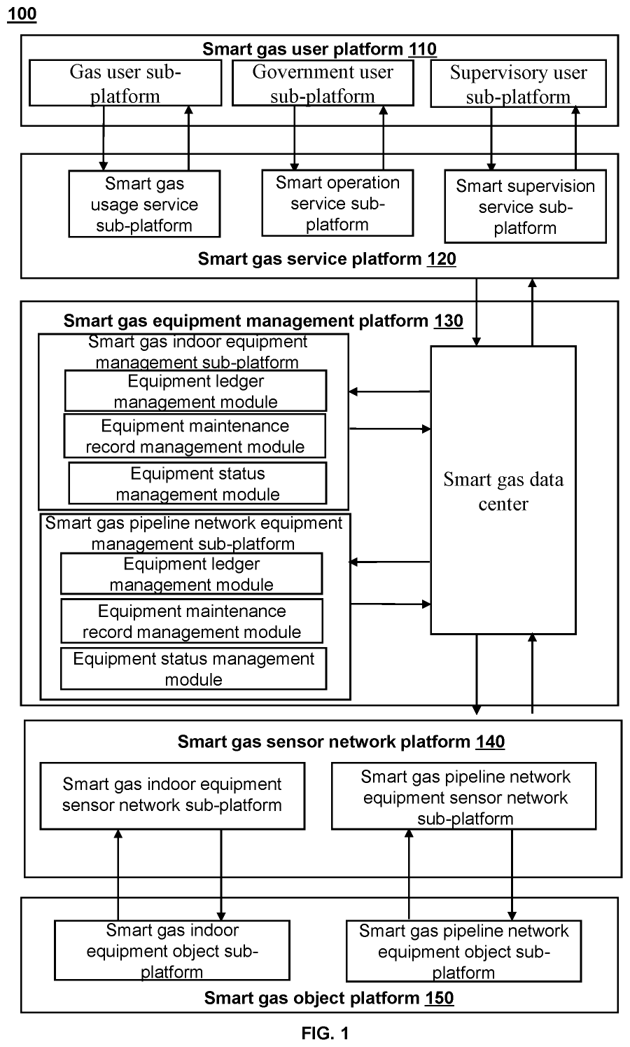

FIG. 1 is a diagram illustrating a platform structure of an IoT system 100 for full-cycle management of smart gas equipment based on big data according to some embodiments of the present disclosure. It should be noted that the following embodiments are only used to explain the present disclosure, and do not constitute a limitation to the present disclosure.

As shown in FIG. 1, the IoT system 100 for full-cycle management of the smart gas equipment based on the big data may include a smart gas user platform 110, a smart gas service platform 120, a smart gas equipment management platform 130, a smart gas sensor network platform 140, and a smart gas object platform 150.

The smart gas user platform 110 refers to a platform that interacts with users. In some embodiments, the smart gas user platform 110 may be configured as a terminal device.

In some embodiments, the smart gas user platform 110 may include a gas user sub-platform, a government user sub-platform, and a supervisory user sub-platform. The gas user sub-platform refers to a platform that provides gas users with data related to gas usage and solutions to gas problems. The government user sub-platform refers to a platform that provides data related to gas operation to government users (e.g., managers of gas operation entities). The supervisory user sub-platform refers to a platform that supervises operation of the entire IoT system for supervisory users (e.g., personnel from a safety management department).

In some embodiments, the smart gas user platform 110 may feed relevant information to the users through the terminal device. For example, the smart gas user platform 110 may feed a health status of the gas equipment and a maintenance scheme corresponding to the health status of the gas equipment after an assessment update back to the supervisory users based on the supervisory user sub-platform.

The smart gas service platform 120 refers to a platform configured to communicate user needs and control information.

In some embodiments, the smart gas service platform 120 may obtain the maintenance scheme for the gas equipment from the smart gas equipment management platform 130 (e.g., the smart gas data center), and upload the maintenance scheme for the gas equipment to the smart gas user platform 110.

In some embodiments, the smart gas service platform 120 may include a smart gas usage service sub-platform, a smart operation service sub-platform, and a smart supervision service sub-platform. The smart gas usage service sub-platform refers to a platform that provides gas usage services to the users. The smart operation service sub-platform refers to a platform that provides the government users with information related to gas operation (e.g., gas equipment management information, etc.). The smart supervision service sub-platform refers to a platform that provides the supervisory users with supervisory needs or supervisory solutions.

In some embodiments, the smart gas service platform 120 may receive the maintenance scheme for the gas equipment from the smart gas data center, and send the maintenance scheme for the gas equipment to the supervisory user sub-platform based on the smart supervision service sub-platform.

The smart gas equipment management platform 130 refers to a platform that coordinates and harmonizes connection and collaboration between various functional platforms, and aggregates all information of the IoT to provide perception, control, or other management functions for an IoT operation system.

In some embodiments, the smart gas equipment management platform 130 may include a smart gas indoor equipment management sub-platform, a smart gas pipeline network equipment management sub-platform, and a smart gas data center.

The smart gas indoor equipment management sub-platform refers to a platform configured to process information related to indoor equipment. The smart gas pipeline network equipment management sub-platform refers to a platform configured to process information related to pipeline network equipment. In some embodiments, the smart gas indoor equipment management sub-platform and the smart gas pipeline network equipment management sub-platform may include an equipment ledger management module, an equipment maintenance record management module, and an equipment status management module, respectively. The smart gas indoor equipment management sub-platform or the smart gas pipeline network equipment management sub-platform may analyze and process the operation data of the gas equipment through the management modules.

The smart gas data center may be configured to store and manage all operational information of the IoT system 100 for full-cycle management of the smart gas equipment based on the big data. In some embodiments, the smart gas data center may be configured as a storage device for storing data (e.g., an operation duration, and an operation status of the gas equipment) related to operation of the gas equipment, or the like.

In some embodiments, the smart gas equipment management platform 130 may perform information interaction with the smart gas service platform 120 and the smart gas sensor network platform 140 through the smart gas data center, respectively. For example, the smart gas data center may send the maintenance scheme for the gas equipment to the smart gas service platform 120. As another example, the smart gas data center may obtain the operation data of the gas equipment from the smart gas object platform 150 by sending an instruction of obtaining the operation data of the gas equipment sent by the smart gas equipment management platform 130 to the smart gas sensor network platform 140.

The smart gas sensor network platform 140 refers to a functional platform that manages sensor communication. In some embodiments, the smart gas sensor network platform 140 may be configured as a communication network and a gateway to fulfill the functions of perception information sensor communication and control information sensor communication.

In some embodiments, the smart gas sensor network platform 140 may include a smart gas indoor equipment sensor network sub-platform and a smart gas pipeline network equipment sensor network sub-platform which are configured to obtain operation data of gas indoor equipment and gas pipeline network equipment, respectively.

In some embodiments, the smart gas sensor network platform 140 may perform data interaction with the smart gas equipment management platform 130 and the smart gas object platform 150 to realize the functions of perception information sensor communication and control information sensor communication. For example, the smart gas sensor network platform 140 may receive an instruction of obtaining data related to the gas equipment (e.g., the operation data) issued by the smart gas data center, and upload the data related to the gas equipment to the smart gas data center. The smart gas object platform 150 refers to a platform for generating perception information and executing control information. For example, the smart gas object platform 150 may monitor and generate the operation data of the gas indoor equipment and the gas pipeline network equipment.

In some embodiments, the smart gas object platform 150 may include a smart gas indoor equipment object sub-platform and a gas pipeline network equipment object sub-platform. In some embodiments, the smart gas indoor equipment object sub-platform may be configured as various types of gas indoor equipment and monitoring equipment of the gas users. The gas pipeline network equipment object sub-platform may be configured as various types of gas pipeline network equipment and monitoring equipment.

In some embodiments, the smart gas indoor equipment object sub-platform may upload the operation data of the indoor equipment to the smart gas data center through the smart gas indoor equipment sensor network sub-platform. The smart gas pipeline network equipment object sub-platform may upload the operation data of the pipeline network equipment to the smart gas data center through the smart gas pipeline network equipment sensor network sub-platform.

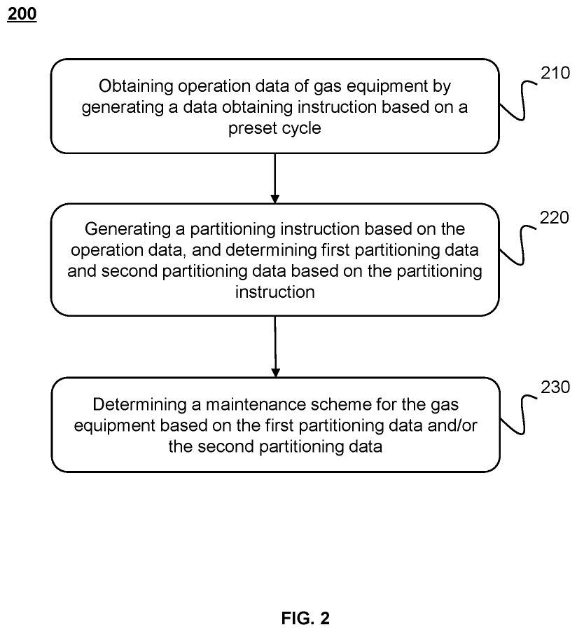

More details regarding the operation data, the maintenance scheme, etc., of the gas equipment may be found elsewhere in the present disclosure (e.g., FIG. 2).

In some embodiments of the present disclosure, the IoT system 100 for full-cycle management of the smart gas equipment based on the big data may form a closed loop of information operation between the smart gas object platform 150 and the smart gas user platform 110, and coordinate and regularly operate under unified management of the smart gas equipment management platform 130, thereby achieving informatization and intellectualization of gas equipment management.

It should be noted that the description of the IoT system 100 for full-cycle management of the smart gas equipment based on the big data and modules thereof is for ease of description only, and does not limit the present disclosure to the scope of the specific embodiments cited. It should be understood that for those skilled in the art, after understanding the principles of the system, it may be possible to make arbitrary combinations of the modules or to form subsystems connected with other modules without departing from the principles.

FIG. 2 is a flowchart illustrating a method for full-cycle management of smart gas equipment based on big data according to some embodiments of the present disclosure. As shown in FIG. 2, a process 200 may include the following operations. In some embodiments, the process 200 may be performed by a smart gas equipment management platform of an IoT system for full-cycle management of smart gas equipment based on big data.

In 210, operation data of gas equipment may be obtained by generating a data obtaining instruction based on a preset cycle.

The preset cycle refers to a pre-set time period for obtaining the operation data. In some embodiments, the preset cycle may be set in advance based on experience.

The data obtaining instruction refers to a command for obtaining data. In some embodiments, the smart gas service platform may generate the data obtaining instruction based on the preset cycle.

The operation data refers to relevant data generated during operation of the gas equipment. For example, the operation data may include an operation duration, operation power, and power consumption of the gas equipment.

In some embodiments, the smart gas equipment management platform may obtain the operation data of the gas equipment by issuing the data obtaining instruction to the smart gas object platform.

In 220, a partitioning instruction may be generated based on the operation data, and first partitioning data and second partitioning data may be determined based on the partitioning instruction.

The partitioning instruction refers to a command used to divide the first partitioning data and the second partitioning data. For example, the partitioning instruction may include a command used to divide a portion of the operation data into the first partitioning data and divide another portion of the operation data into the second partitioning data. In some embodiments, the smart gas equipment management platform may generate the partitioning instruction based on a preset partitioning rule.

The first partitioning data refers to normal operation data of the gas equipment. The second partitioning data refers to sub-normal operation data of the gas equipment. The normal operation data is operation data at an optimal operation status of the gas equipment. The sub-normal operation data is operation data that is neither abnormal operation data nor normal operation data. The normal operation data and the abnormal operation data may be determined based on a preset data determination criterion.

In some embodiments, the smart gas equipment management platform may determine the first partitioning data and the second partitioning data in various ways. For example, the smart gas equipment management platform may set a boundary value for the operation data of each type of gas equipment through prior knowledge, and generate the partitioning instruction based on the boundary value. The smart gas equipment management platform may arrange the operation data in a descending order, and then determine the operation data within the boundary value as the first partitioning data, and the operation data outside the boundary value as the second partitioning data based on the partitioning instruction.

It should be noted that a plurality of gas equipment may be provided in a gas pipeline network. The smart gas equipment management platform may determine a maintenance scheme corresponding to the gas equipment by determining the first partitioning data and the second partitioning data for a set of operation data corresponding to each gas equipment.

In some embodiments, the smart gas equipment management platform may determine a partitioning threshold based on equipment information and the operation data of the gas equipment, and determine the first partitioning data and the second partitioning data based on the partitioning threshold.

The equipment information refers to information related to equipment usage. For example, the equipment information may include an equipment model, an equipment operation environment, an equipment usage duration, an equipment operation status, and equipment power consumption. In some embodiments, the smart gas equipment management platform may obtain the equipment information of the gas equipment based on the smart gas object platform.

The partitioning threshold refers to a threshold used to divide the first partitioning data and the second partitioning data. The smart gas equipment management platform may determine the partitioning threshold in various ways. For example, the smart gas equipment management platform may determine a midpoint between the first partitioning data (i.e., the normal operation data) and the abnormal operation data, and use the midpoint as a basic partitioning threshold.

For example, if a mean or a median of the normal operation data in a segment of operation data is 10, and a determination standard value for the abnormal operation data is 18 (i.e., the operation data is considered abnormal if the operation data exceeds 18), the midpoint may be 14; if the determination standard value for the abnormal operation data is 4 (i.e., the operation data is considered abnormal if the operation data is below 4), the midpoint may be 7. That is, two partitioning thresholds may be provided.

In some embodiments, the smart gas equipment management platform may determine a final partitioning threshold by adjusting the basic partitioning threshold based on the equipment operation environment and the equipment usage duration. For example, for a same type of equipment, the harsher the equipment operation environment and the longer the equipment usage duration of the gas equipment, the more the partitioning threshold may tend to the normal data.

In some embodiments, the smart gas equipment management platform may arrange the operation data in a descending order, and then determine the operation data as the first partitioning data or the second partitioning data based on the partitioning threshold.

In some embodiments of the present disclosure, the operation data may be divided by setting the partitioning threshold, and the partitioning threshold may be related to the equipment information, thereby improving the rationality of dividing the operation data, and providing reasonable data support for determining the maintenance scheme based on the first partitioning data and the second partitioning data, thus improving the rationality of determining the maintenance scheme. For example, for the same type of equipment, the harsher the equipment operation environment and the longer the equipment usage duration of certain gas equipment, the more the partitioning threshold may tend to the normal data, thereby improving maintenance effort for gas equipment in the harsher equipment operation environment and longer equipment usage duration.

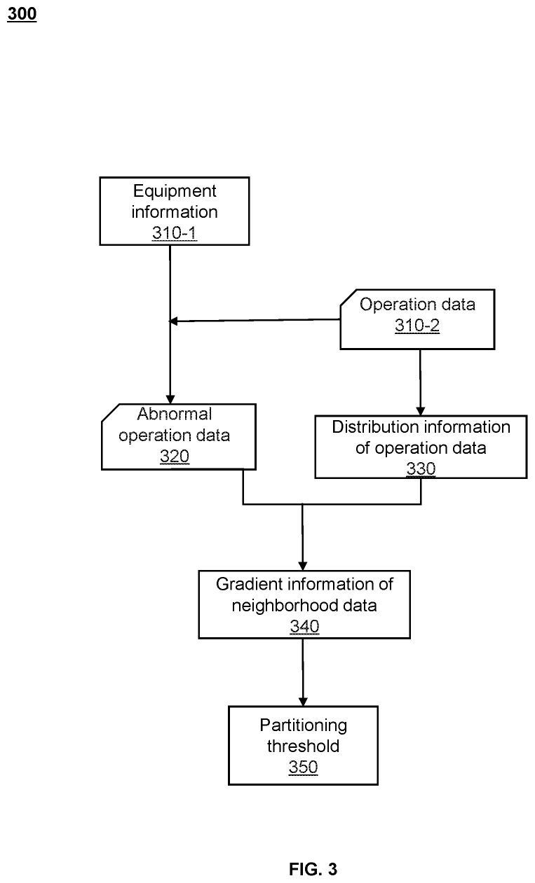

In some embodiments, more details regarding the smart gas equipment management platform determining the partitioning threshold based on the equipment information and the operation data may be found in FIG. 3 and related descriptions thereof.

In 230, the maintenance scheme for the gas equipment may be determined based on the first partitioning data and/or the second partitioning data.

The maintenance scheme refers to a maintenance plan formulated to ensure proper use or extend service life of the gas equipment. In some embodiments, the maintenance scheme may include the maintenance cycle and/or the maintenance degree of the gas equipment. The maintenance cycle refers to a cycle at which the gas equipment is inspected and maintained, i.e., a time interval between two consecutive times of maintenance. The maintenance degree refers to an extent of inspection and maintenance. For example, the maintenance degree may include simple visual inspection, detailed inspection of an interior, a degree of detailed inspection, etc. In some embodiments, the maintenance degree may be determined based on a complexity degree of an internal structure of the gas equipment. The higher the complexity degree of the internal structure, the higher the maintenance degree.

The smart gas equipment management platform may determine the maintenance scheme in various ways. In some embodiments, the maintenance scheme may be related to a volume of the second partitioning data. For example, the more the second partitioning data, the shorter the maintenance cycle, and the higher the maintenance degree.

In some embodiments, the smart gas equipment management platform may determine the maintenance scheme by assessing a health status of the gas equipment. More details may be found in the related descriptions below.

In some embodiments of the present disclosure, assessment and analysis of the usual health status of the gas equipment may be accurately realized by dividing the operation data of the gas equipment into the first partitioning data and the second partitioning data, thereby determining the maintenance scheme for the gas equipment, and providing data support for the usage, maintenance, repair, and overhaul of the gas equipment.

It should be noted that the preceding description of the process 200 is provided for the purpose of example and illustration only, and does not limit the scope of the present disclosure. Those skilled in the art may make various modifications and changes to the process 200 under the guidance of the present disclosure. However, such modifications and changes remain within the scope of the present disclosure.

FIG. 3 is a schematic diagram illustrating a determination of a partitioning threshold according to some embodiments of the present disclosure.

In some embodiments, the smart gas equipment management platform may determine distribution information of operation data based on the operation data, and determine the partitioning threshold based on equipment information and the distribution information of the operation data.

The distribution information refers to a distribution of the operation data over time. The distribution information may be represented by a coordinate graph where a horizontal coordinate represents time and a vertical coordinate represents the operation data.

In some embodiments, the smart gas equipment management platform may determine the distribution information by arranging or summarizing the operation data within a preset time period based on time.

In some embodiments, the smart gas equipment management platform may obtain a plurality of sets of operation data of a plurality of gas equipment with same equipment information, and obtain extreme values of the plurality of sets of operation data by determining an extreme value of each set of operation data based on the distribution information of each set of operation data. The smart gas equipment management platform may calculate an average value of the extreme values of the plurality of sets of operation data, and determine the partitioning threshold based on the average value. For example, the partitioning threshold may be 80% of the average value of the extreme values of the plurality of sets of operation data.

In some embodiments of the present disclosure, the partitioning threshold may be determined more accurately by analyzing the distribution information of the operation data in combination with the equipment information, thereby achieving reasonable division of the operation data.

In some embodiments, the smart gas service platform may identify abnormal operation data 320 in operation data 310-2 based on equipment information 310-1, determine gradient information 340 of neighborhood data based on the distribution information 330 of the operation data and the abnormal operation data 320, and determine a partitioning threshold 350 based on the gradient information 340 of the neighborhood data.

The abnormal operation data 320 refers to operation data of the gas equipment in case of abnormality.

In some embodiments, the smart gas equipment management platform may mark the operation data 310-2 of the gas equipment in case of abnormality as the abnormal operation data 320 based on the equipment information 310-1. For example, the smart gas equipment management platform may identify operation data in case of abnormal equipment power consumption as the abnormal operation data based on equipment power consumption in the equipment information 310-1.

The neighborhood data refers to operation data within a preset time period (or within a neighborhood range) before and after a time point of the abnormal operation data 320. In some embodiments, the smart gas equipment management platform may determine a change in the operation data as the equipment transitions from normal to abnormal based on the neighborhood data.

The gradient information 340 of the neighborhood data may indicate a change rate of the neighborhood data based on time. For example, the greater the drop in the gradient information of the neighborhood data, the faster the change of the neighborhood data. In some embodiments, the smart gas equipment management platform may determine the gradient information 340 of the neighborhood data based on the change of the neighborhood data.

In some embodiments, the neighborhood data may be located within a neighborhood range of the abnormal data. In some embodiments, the neighborhood range may be determined based on a time interval between occurrences of the abnormal operation data and historical health statuses of the gas equipment.

The neighborhood range refers to time intervals consecutive to the abnormal operation data. For example, on a time axis of the distribution of the operation data over time, assuming that the abnormal operation data is located within a range of 50s-60s, the neighborhood range may be a time interval consecutive to the distribution time of the abnormal operation data, such as 40s-50s and 60s-70s, and a size of the neighborhood range may be 10s. In some embodiments, the size of the neighborhood range may be negatively correlated with the time interval between the occurrences of the abnormal operation data and the historical health statuses of the gas equipment. For example, the larger the time interval between the occurrences of the abnormal operation data, the smaller the neighborhood range; or the better the historical health statuses of the gas equipment, the smaller the neighborhood range.

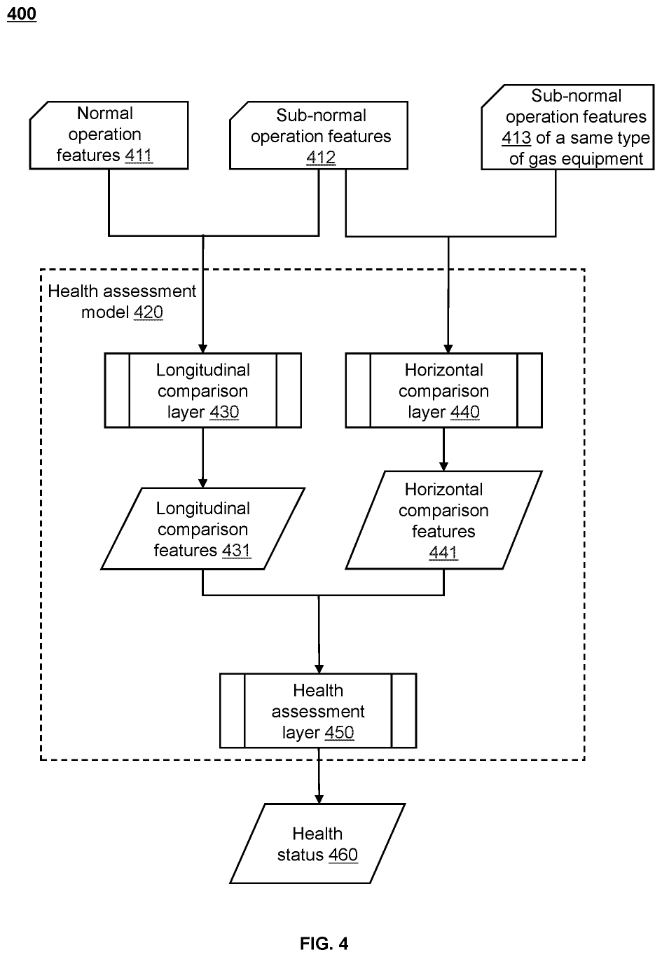

The historical health statuses refer to health statuses of the gas equipment as assessed in historical periods. More descriptions regarding determining the health statuses of the gas equipment may be found in FIG. 4 and related descriptions thereof.

In some embodiments of the present disclosure, by considering the time interval between the occurrences of the abnormal operation data and the historical health statuses of the gas equipment, the neighborhood range may be more realistic, thereby determining the partitioning threshold in a more reasonable manner.

In some embodiments, in response to a determining that a change of the gradient information 340 of the neighborhood data satisfies a preset change condition, the smart gas equipment management platform may expand the neighborhood range.

The preset change condition refers to a condition that need to be satisfied to expand the neighborhood range. For example, the preset change condition may be that the change of the gradient information 340 of the neighborhood data is greater than a preset change threshold.

In some embodiments, an expansion value of the neighborhood range may be positively correlated with the change of the gradient information 340 of the neighborhood data.

If the change of the gradient information of the neighborhood data is greater than the change threshold, it may indicate that data at a time point when the equipment starts to change from the normal operation to the abnormal operation is not within the neighborhood range (i.e., a time point when an operation status of the equipment starts to change is not within the neighborhood range), and the neighborhood range may be expanded for analysis. In some embodiments of the present disclosure, by expanding the neighborhood range in response to a determining that the change of the gradient information satisfies the preset change condition, the neighborhood range may be more realistically determined, and thus the partitioning threshold may be better determined.

In some embodiments, the smart gas equipment management platform may search for a starting time point when the gradient information consistently exceeds a preset gradient reference value within the neighborhood range, and may use the operation data 310-2 corresponding to the starting time point as the partitioning threshold 350.

In some embodiments, if a plurality of neighborhood ranges of abnormal operation data are provided, a plurality of starting time points may be determined in the plurality of neighborhood ranges, and an average value of the operation data 310-2 corresponding to the plurality of starting time points may be used as the partitioning threshold 350. The gradient reference value may be preset based on experience.

For example, from a certain time point, if the gradient information of the operation data continuously exceeds the preset gradient reference value, causing the operation data to continuously increase until the operation data becomes abnormal, the time point may be starting (i.e., the starting time point) of the change of data from normal to abnormal, and the operation data corresponding to the starting time point may be used as the partitioning threshold.

In some embodiments of the present disclosure, the partitioning threshold may be determined more accurately by identifying the abnormal operation data and analyzing the gradient information of the neighborhood data, thereby reducing the computational pressure.

FIG. 4 is a schematic diagram illustrating a determination of a health status based on a model according to some embodiments of the present disclosure.

In some embodiments, the smart gas equipment management platform may assess a health status 460 of the gas equipment based on the first partitioning data and the second partitioning data, and determine the maintenance scheme based on the health status 460.

The health status 460 refers to data used to measure a goodness degree of the gas equipment. For example, the health status 460 may be data used to measure whether the operation status of the gas equipment is normal, or whether components of the gas equipment are in good condition, etc.

The smart gas equipment management platform may assess the health status 460 of the gas equipment in various ways. In some embodiments, the health status 460 may be positively correlated with a proportion of the first partitioning data to a sum of the first partitioning data and the second partitioning data. The larger the proportion of the first partitioning data to the sum of the first partitioning data and the second partitioning data, the better the health status 460. In some embodiments, the smart gas equipment management platform may directly determine the proportion of the first partitioning data to the sum of the first partitioning data and the second partitioning data as the health status 460 of the gas equipment.

In some embodiments, the smart gas equipment management platform may determine normal operation features 411 of the gas equipment based on the first partitioning data, determine sub-normal operation features 412 of the gas equipment based on the second partitioning data and the normal operation features 411, and determine the health status 460 based on normal operation features 411, the sub-normal operation features 412, and sub-normal operation features 413 of a same type of gas equipment.

The normal operation features 411 refer to features of the normal operation data. For example, the normal operation features 411 may include an average value, a fluctuation frequency and magnitude, and a frequency of different fluctuation magnitudes of the first partitioning data. The fluctuation frequency and magnitude refer to a frequency and a magnitude of differences in consecutive first partitioning data.

In some embodiments, the smart gas equipment management platform may determine the normal operation features 411 by performing statistical analysis of the first partitioning data.

The sub-normal operation features 412 refer to features of the sub-normal operation data. For example, the sub-normal operation features 412 may include a count of sub-normal occurrences, a sub-normal time interval, a sub-normal magnitude, or the like. The count of sub-normal occurrences refers to a count of the second partitioning data occurrences. The second partitioning data occurring once refers to a segment of sub-normal operation data continuously occurring in the operation data of the gas equipment. A count of segments of the second partitioning data in the operation data of the gas equipment may indicate the count of sub-normal occurrences. The sub-normal time interval refers to time between two consecutive sub-normal occurrences. The sub-normal magnitude refers to a difference between the second partitioning data and the average value of the first partitioning data.

In some embodiments, the smart gas equipment management platform may determine the sub-normal operation features 412 by analyzing the second partitioning data and the normal operation features 411.

For example, the smart gas equipment management platform may determine the count of sub-normal occurrences and the subnormal interval in the sub-normal operation features by analyzing the second partitioning data.

As another example, the smart gas equipment management platform may determine the difference between the second partitioning data and the average value of the first partitioning data in the normal operation features, and determine the sub-normal magnitude in the sub-normal operation features based on the difference.

The same type of gas equipment refers to other gas equipment that has same equipment information and a same or similar partitioning threshold as the current gas equipment.

The determination of the sub-normal operation features 413 of the same type of gas equipment may be similar to the determination of the sub-normal operation features 412 of the gas equipment, and may be found in the description above.

In some embodiments, the health status 460 may be negatively correlated with the fluctuation frequency and magnitude, and the frequency of different fluctuation magnitudes in the normal operation features 411. The health status 460 may also be negatively correlated with the count of sub-normal occurrences in the sub-normal operation feature 412, and positively correlated with the sub-normal interval in the sub-normal operation features 412. In addition, if the sub-normal features 412 of the present gas equipment are small relative to the sub-normal features 413 of the same type of gas equipment, the health status may be good; or if the sub-normal features 412 of the present gas equipment are large relative to the sub-normal features 413 of the same type of gas equipment, the health status may be poor.

In some embodiments of the present disclosure, the normal operation status and features of the gas equipment may be understood by analyzing the normal features, and the normal features may provide a reference standard to help identify the sub-normal features of the equipment. In addition, the health status of the equipment may be determined more accurately by comparing with the sub-normal operation features of the same type of gas equipment, which helps to discover potential problems of the equipment in time, and take appropriate measures to maintain the safe and stable operation of the equipment.

In some embodiments, the smart gas equipment management platform may determine the health status 460 by processing the normal operation features 411, the sub-normal operation features 412, and the sub-normal operation features 413 of the same type of gas equipment through a health assessment model 420.

In some embodiments, the health assessment model 420 may be a machine learning model with a customized structure as described below. In some embodiments, the health assessment model 420 may also be a machine learning model of another structure, such as a neural network model, etc.

In some embodiments of the present disclosure, the normal operation features, the sub-normal operation features, and the sub-normal operation features of the same type of gas equipment may be processed using the health assessment model. A correlation relationship between the health status and the operation features may be obtained by finding patterns from a large amount of operation features using the self-learning capability of the machine learning model, thereby improving the accuracy and efficiency of determining the operation features.

In some embodiments, the health assessment model 420 may include a longitudinal comparison layer 430, a horizontal comparison layer 440, and a health assessment layer 450. The longitudinal comparison layer 430 may determine longitudinal comparison features 431 by processing the normal operation features 411 and the sub-normal operation features 412. The horizontal comparison layer 440 may determine horizontal comparison features 441 by processing the sub-normal operation features 412 and the sub-normal operation features 413 of the same type of gas equipment. The health assessment layer 450 may determine the health status 460 by processing the longitudinal comparison features 431 and the horizontal comparison features 441.

In some embodiments, the longitudinal comparison layer 430, the horizontal comparison layer 440, and the health assessment layer 450 may be neural networks.

The longitudinal comparison features 431 refer to comparative data of operation features of same gas equipment in different statuses. That is, the longitudinal comparison features may be comparative data of the normal operation features 411 and the sub-normal operation features 412 of the same gas equipment.

The horizontal comparison features 441 refer to comparative data of operation features of the same type of gas equipment. That is, the horizontal comparison features may be comparative data of the sub-normal operation features 412 of current gas equipment and the sub-normal operation features 413 of the same type of gas equipment.

More descriptions regarding the normal operation features 411, the sub-normal operation features 412, the sub-normal operation features 413 of the same type of gas equipment, and the health status 460 may be found in the related descriptions above.

In some embodiments, outputs of the longitudinal comparison layer 430 and the horizontal comparison layer 440 may serve as inputs to the health assessment layer 450. The longitudinal comparison layer 430, the horizontal comparison layer 440, and the health assessment layer 450 may be obtained by jointly training.

In some embodiments, sample data for joint training may include sample normal operation features of sample equipment, sample sub-normal operation features of the sample equipment, and sub-normal operation features of same type of gas equipment of the sample equipment. Labels may be an actual health status of the sample equipment.

In some embodiments, the smart gas equipment management platform may obtain initial longitudinal comparison features by inputting the sample normal operation features and sample sub-normal operation features into an initial longitudinal comparison layer. The smart gas equipment management platform may obtain initial horizontal comparison features by inputting the sample sub-normal operation features and the sub-normal operation features of the sample same type of gas equipment into an initial horizontal comparison layer. The smart gas equipment management platform may obtain an initial health status by inputting the initial longitudinal comparison features and the initial horizontal comparison features as training sample data into an initial health assessment layer. A loss function may be constructed based on the labels and the initial health status. The initial longitudinal comparison layer, the initial horizontal comparison layer, and the initial health assessment layer may be updated simultaneously using the loss function.

In some embodiments, the smart gas equipment management platform may obtain sample data based on historical data (e.g., historical normal operation features and historical sub-normal operation features of a plurality of same type of gas equipment). In some embodiments, the smart gas equipment management platform may determine a time interval from statistics of the sub-normal operation features to occurrence of a first failure of each gas equipment in a historical period, and determine the health status based on the time interval as a label. For example, the longer the time interval from the statistics of the sub-normal operation features to the occurrence of the first failure, the better the health status.

In some embodiments of the present disclosure, the health assessment model may include the longitudinal comparison layer, the horizontal comparison layer, and the health assessment layer, and different data may be processed separately through these layers, thereby improving data processing efficiency and accuracy.

In some embodiments, the smart gas equipment management platform may determine a maintenance scheme for the gas equipment based on the health status 460. In some embodiments, a maintenance cycle in the maintenance scheme may be positively correlated with the health status 460, and a maintenance degree in the maintenance scheme may be negatively correlated with the health status 460.

In some embodiments of the present disclosure, by combining the first partitioning data and the second partitioning data, the health status of the gas equipment may be more accurately assessed, thereby better identifying potential problems and working conditions of the equipment; and by determining the maintenance scheme based on the health status, a more suitable maintenance cycle and maintenance degree of the equipment may be be formulated, thereby improving the maintenance effectiveness of the gas equipment, and prolonging the service life of the gas equipment.

Embodiments of the present disclosure further provide a non-transitory computer-readable storage medium, comprising computer instructions that, when read by a computer, may direct the computer to perform the method for full-cycle management of the smart gas equipment based on the big data described in any one of the embodiments of the present disclosure.

The basic concept has been described above. Obviously, for those skilled in the art, the above detailed disclosure is only an example, and does not constitute a limitation to the present disclosure. Although not expressly stated here, those skilled in the art may make various modifications, improvements and corrections to the present disclosure. Such modifications, improvements and corrections are suggested in this disclosure, so such modifications, improvements and corrections still belong to the spirit and scope of the exemplary embodiments of the present disclosure.

Meanwhile, the present disclosure uses specific words to describe the embodiments of the present disclosure. For example, “one embodiment”, “an embodiment”, and/or “some embodiments” refer to a certain feature, structure or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures or characteristics in one or more embodiments of the present disclosure may be properly combined.

In addition, unless clearly stated in the claims, the sequence of processing elements and sequences described in the present disclosure, the use of counts and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in this disclosure and help the understanding of one or more embodiments of the invention, in the foregoing description of the embodiments of the present disclosure, sometimes multiple features are combined into one embodiment, drawings or descriptions thereof. This method of disclosure does not, however, imply that the subject matter of the disclosure requires more features than are recited in the claims. Rather, claimed subject matter may lie in less than all features of a single foregoing disclosed embodiment.

In some embodiments, counts describing the quantity of components and attributes are used. It should be understood that such counts used in the description of the embodiments use the modifiers “about”, “approximately” or “substantially” in some examples. Unless otherwise stated, “about”, “approximately” or “substantially” indicates that the stated figure allows for a variation of ±20%. Accordingly, in some embodiments, the numerical parameters used in the disclosure and claims are approximations that can vary depending upon the desired characteristics of individual embodiments. In some embodiments, numerical parameters should consider the specified significant digits and adopt the general digit retention method. Although the numerical ranges and parameters used in some embodiments of the present disclosure to confirm the breadth of the range are approximations, in specific embodiments, such numerical values are set as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for full-cycle management of smart gas equipment based on big data, implemented by a smart gas equipment management platform of an Internet of Things (IoT) system for full-cycle management of smart gas equipment based on big data, comprising:
obtaining operation data of gas equipment by generating a data obtaining instruction based on a preset cycle;
generating a partitioning instruction based on the operation data, and determining first partitioning data and second partitioning data based on the partitioning instruction, the first partitioning data being normal operation data of the gas equipment, and the second partitioning data being sub-normal operation data of the gas equipment; and
determining a maintenance scheme for the gas equipment based on the first partitioning data and/or the second partitioning data, the maintenance scheme including a maintenance cycle and/or a maintenance degree of the gas equipment.

2. The method of claim 1, wherein the generating a partitioning instruction based on the operation data, and determining first partitioning data and second partitioning data based on the partitioning instruction includes:
determining a partitioning threshold based on equipment information and the operation data of the gas equipment; and
determining the first partitioning data and the second partitioning data based on the partitioning threshold.

3. The method of claim 2, wherein the determining a partitioning threshold based on equipment information and the operation data of the gas equipment includes:
determining distribution information of the operation data based on the operation data; and
determining the partitioning threshold based on the equipment information and the distribution information of the operation data.

4. The method of claim 3, wherein the determining the partitioning threshold based on the equipment information and the distribution information of the operation data includes:
identifying abnormal operation data of the operation data based on the equipment information;
determining gradient information of neighborhood data based on the distribution information of the operation data and the abnormal operation data; and
determining the partitioning threshold based on the gradient information of the neighborhood data.

5. The method of claim 4, wherein
the neighborhood data is located within a neighborhood range of the abnormal data; and
the neighborhood range is determined based on a time interval when the abnormal operation data occurs and a historical health status of the gas equipment.

6. The method of claim 5, further comprising:
in response to a determining that a change of the gradient information satisfies a preset change condition, expanding the neighborhood range.

7. The method of claim 1, wherein the determining a maintenance scheme for the gas equipment based on the first partitioning data and/or the second partitioning data includes:
assessing a health status of the gas equipment based on the first partitioning data and the second partitioning data; and
determining the maintenance scheme based on the health status.

8. The method of claim 7, wherein the assessing a health status of the gas equipment based on the first partitioning data and the second partitioning data includes:
determining normal operation features of the gas equipment based on the first partitioning data;
determining sub-normal operation features of the gas equipment based on the second partitioning data and the normal operation features; and
determining the health status based on the normal operation features, the sub-normal operation features, and sub-normal operation features of a same type of gas equipment.

9. The method of claim 8, wherein the determining the health status based on the normal operation features, the sub-normal operation features, and sub-normal operation features of a same type of gas equipment includes:
determining the health status by processing the normal operation features, the sub-normal operation features, and the sub-normal operation features of the same type of gas equipment through a health assessment model, the health assessment model being a machine learning model.

10. The method of claim 9, wherein
the health assessment model includes a longitudinal comparison layer, a horizontal comparison layer, and a health assessment layer;
the longitudinal comparison layer is configured to determine longitudinal comparison features by processing the normal operation features and the sub-normal operation features;
the horizontal comparison layer is configured to determine horizontal comparison features by processing the sub-normal operation features and the sub-normal operation features of the same type of gas equipment; and
the health assessment layer is configured to determine the health status by processing the longitudinal comparison features and the horizontal comparison features.

11. An Internet of Things (IoT) system for full-cycle management of smart gas equipment based on big data, comprising a smart gas user platform, a smart gas service platform, a smart gas equipment management platform, a smart gas sensor network platform, and a smart gas object platform, wherein
the smart gas user platform includes a plurality of smart gas user sub-platforms;
the smart gas service platform includes a plurality of smart gas service sub-platforms, and different smart gas service sub-platforms correspond to different smart gas user sub-platforms;
the smart gas equipment management platform includes a plurality of smart gas equipment management sub-platforms and a smart gas data center;
the smart gas sensor network platform is configured to interact with the smart gas data center and the smart gas object platform;
the smart gas object platform is configured to obtain operation data of gas equipment based on a data obtaining instruction generated in a preset cycle, and upload the operation data of the gas equipment to the smart gas data center based on the smart gas sensor network platform;
the smart gas equipment management platform is configured to:
obtain the operation data of the gas equipment from the smart gas data center;
generate a partitioning instruction based on the operation data, and determine first partitioning data and second partitioning data based on the partitioning instruction, the first partitioning data being normal operation data of the gas equipment, and the second partitioning data being sub-normal operation data of the gas equipment;
determine a maintenance scheme for the gas equipment based on the first partitioning data and/or the second partitioning data, the maintenance scheme including a maintenance cycle and/or a maintenance degree of the gas equipment; and
transmit the maintenance scheme to the smart gas service platform through the smart gas data center; and
the smart gas service platform is configured to upload the maintenance scheme to the smart gas user platform.

12. The system of claim 11, wherein the smart gas equipment management platform is further configured to:
determine a partitioning threshold based on equipment information and the operation data of the gas equipment; and
determine the first partitioning data and the second partitioning data based on the partitioning threshold.

13. The system of claim 12, wherein the smart gas equipment management platform is further configured to:
determine distribution information of the operation data based on the operation data; and
determine the partitioning threshold based on the equipment information, and the distribution information of the operation data.

14. The system of claim 13, wherein the smart gas equipment management platform is further configured to:
identify abnormal operation data of the operation data based on the equipment information;
determine gradient information of neighborhood data based on the distribution information of the operation data, and the abnormal operation data; and
determine the partitioning threshold based on the gradient information of the neighborhood data.

15. The system of claim 14, wherein the neighborhood data is located within a neighborhood range of the abnormal operation data; and the neighborhood range is determined based on a time interval when the abnormal operation data occurs, and a historical health status of the gas equipment.

16. The system of claim 15, wherein the smart gas equipment management platform is further configured to:
in response to a determining that a change of the gradient information satisfies a preset change condition, expand the neighborhood range.

17. The system of claim 11, wherein the smart gas equipment management platform is further configured to:
assess a health status of the gas equipment based on the first partitioning data and the second partitioning data; and
determine the maintenance scheme based on the health status.

18. The system of claim 17, wherein the smart gas equipment management platform is further configured to:
determine normal operation features of the gas equipment based on the first partitioning data;
determine sub-normal operation features of the gas equipment based on the second partitioning data and the normal operation features; and
determine the health status based on the normal operation features, the sub-normal operation features, and sub-normal operation features of a same type of gas equipment.

19. The system of claim 18, wherein the smart gas equipment management platform is further configured to:
determine the health status by processing the normal operation features, the sub-normal operation features, and the sub-normal operation features of the same type of gas equipment through a health assessment model; the health assessment model being a machine learning model.

20. A non-transitory computer-readable storage medium, comprising computer instructions that, when read by a computer, direct the computer to perform the method for full-cycle management of the smart gas equipment based on big data of claim 1.
